(19) United States
(12) Patent Application Publication
(10) Pub. No.: US 2009/0323176 A1
(43) Pub. Date: Dec. 31, 2009

(54) SINGLE WAVELENGTH ULTRAVIOLET LASER DEVICE

(75) Inventors: An-Chi Wei, Chu-Nan (TW); Jyh-Long Chern, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/490,574

(22) Filed: Jun. 24, 2009

(30) Foreign Application Priority Data
Jun. 30, 2008 (CN) 200810302456.8

(51) Int. Cl. G02B 17/08; G02B 13/14; G02B 3/04

(52) U.S. Cl. 359/355; 359/709

(57) ABSTRACT

A laser device includes a laser source and an optical module. The laser source is configured for emitting a UV laser beam with a single wavelength. The optical module includes a first optical element disposed on a light path of the UV laser beam. The first optical element has a first surface and a second surface at opposite sides thereof. The first surface faces toward the laser source. At least one of the first and second surfaces is aspherical such that the UV laser beam is capable of focusing on a focal plane with a satisfactory depth of focus.

### BACKGROUND

1. Technical Field

The present disclosure relates to laser devices, and particularly, to a single wavelength ultraviolet (UV) laser device with a satisfactory depth of focus (DOF).

2. Description of Related Art

With the development of semiconductor technology and mechanical machining, various electronic and photonic devices have been miniaturized to meet the trend toward compactness. In semiconductor lithography technology and in mechanical machining using lasers, UV light is typically employed as the energy source. Because UV light has a short wavelength, high resolution can be achieved, and micro (or nano) sized features with high precision can be obtained.

Since the resolution of the UV laser light in a conventional optical system is inversely proportional to λ/NA (λ is the wavelength of the UV laser light, and NA is a numerical aperture of a corresponding optical element), and since the DOF of the optical element is directly proportional to λ/NA², when the resolution (evaluated by spot size) is enhanced, the DOF is reduced. Consequently, the surface quality of the sample, such as the sharpness of side walls of features and the overall surface roughness, is liable to be unsatisfactory. Thus, how to create a UV light source with a sufficient DOF is a significant challenge for the further development of high-resolution fabrication technologies.

In U.S. Pat. No. 5,303,002, in order to create a long DOF for the optical module with a UV light source, a lens with chromatic aberration is used to focus several narrow bands of radiation from an excimer laser. Because each band is focused at a different focal plane, the overall focuses can contribute to a long DOF. However, the corresponding apparatus requires a special light source with closely spaced and narrow bands. As a result, the uniformity of laser power along the light axis is an issue and the cost of the light source is liable to be high.

In another different kind of method, diffractive optical elements (DOEs) are applied to extend the DOF of a light source. The DOEs can be fabricated by economical semiconductor technology. Nevertheless, a light source with more than one wavelength (or a wide band light source) is still required, and the amount of effective light is reduced due to high order diffraction.

What is needed, therefore, is a laser device which can achieve a satisfactory DOF for UV light in a way that can overcome the above-described difficulties.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a first embodiment of a laser device.

FIG. 2 is a schematic view of a second embodiment of a laser device.

FIG. 3A is a schematic view of a third embodiment of a laser device, showing a first example thereof.

FIG. 3B is a schematic view of a second example of the third embodiment of the laser device.

FIG. 3C is a schematic view of a third example of the third embodiment of the laser device.

FIG. 4 is a schematic view of a fourth embodiment of a laser device.

FIG. 5 is an enlarged view of part of FIG. 4.

### DETAILED DESCRIPTION OF EMBODIMENTS

Embodiments of the present laser device will now be described in detail below and with reference to the drawings.

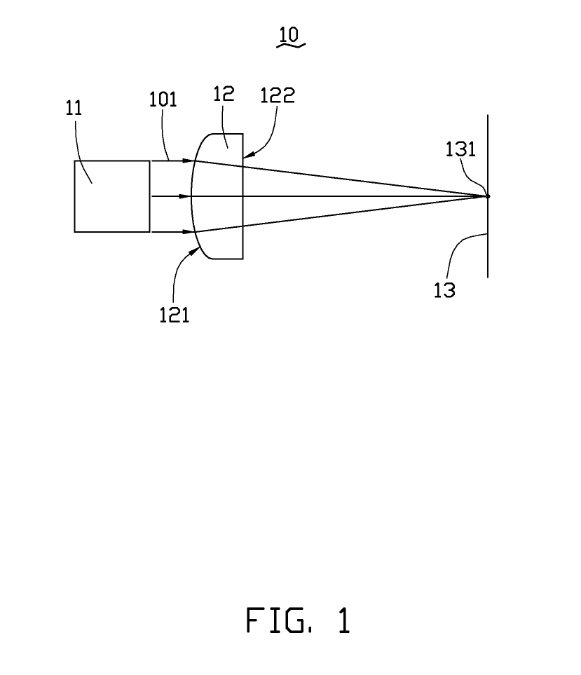

Referring to FIG. 1, a laser device 10 of a first embodiment is provided. The laser device 10 includes a laser source 11 and an optical module 12. The laser source 11 is configured for emitting a UV laser beam 101 with a single wavelength. The optical module 12 is disposed on a light path of the UV laser beam 101, between the laser source 11 and a focal plane 13.

The optical module 12 includes a single optical element. In the illustrated embodiment, the optical element is in the form of a lens, and has a first surface 121 and a second surface 122 at opposite sides thereof. The first surface 121 faces toward the laser source 11, and the second surface 122 faces toward the focal plane 13. At least one of the first and second surfaces 121, 122 is aspherical, and the other one of the first and second surfaces 121, 122 may be flat, spherical, cylindrical or aspherical. In the present embodiment, the first surface 121 is aspherical, and the second surface 122 is flat. The asphericity is defined by conic constants or aspheric coefficients. The UV laser beam 101 is refracted by different regions of the first surface 121 and can be bent to different extents. The UV laser beam 101 exiting the optical module 12 is focused to successive positions along the light path, and thereby extends the DOF of the laser device 10. A light spot 131 derived from the focused UV laser beam 101 is formed on the focal plane 13. Unlike conventional DOF-enhanced apparatuses using a chromatic aberration lens or diffractive optical elements with multiple wavelengths, the laser device 10 uses the at least one aspherical surface of the optical module 12 (e.g., the aspherical first surface 121) to enhance the DOF. In addition, the UV laser beam 101 from the laser device 10 has a single wavelength. Therefore the aspherical first surface 121 does not diffract the UV laser beam 101, whereby the laser device 10 can be highly efficient and economical. Furthermore, the size of the light spot 131 can be maintained as required, i.e., the resolution of the UV laser device 10 can be maintained at a desirable or feasible value.

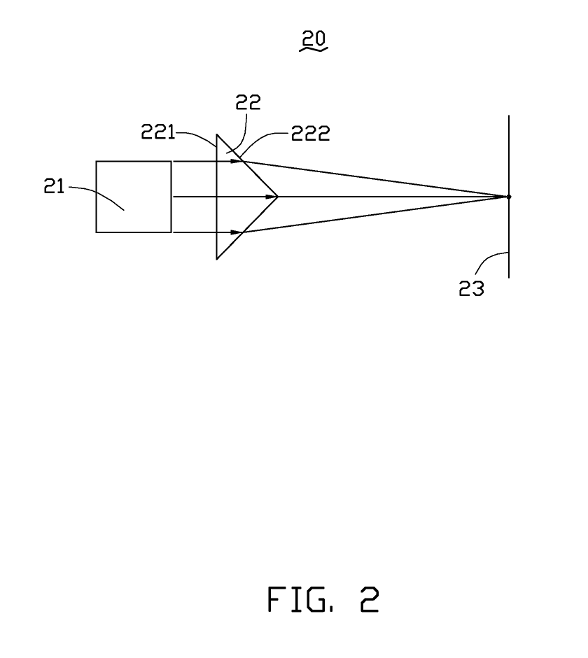

Referring to FIG. 2, a laser device 20 of a second embodiment is provided. An optical module 22 includes a single optical element. The single optical element is substantially an axicon type lens having a first surface 221 facing toward a laser source 21, and an opposite second surface 222 facing toward a focal plane 23. The first surface 221 is flat, and the second surface 222 is conical. The axicon type lens can be a conical lens (e.g. a circular conical lens) or a rotationally symmetric prism. A UV laser beam emitted from the laser source 21 can be refracted by the different regions of the axicon type lens and can be bent to different extents. The UV laser beam exiting the optical module 22 is focused to successive positions along the light path, and thereby extends the DOF of the laser device 20.

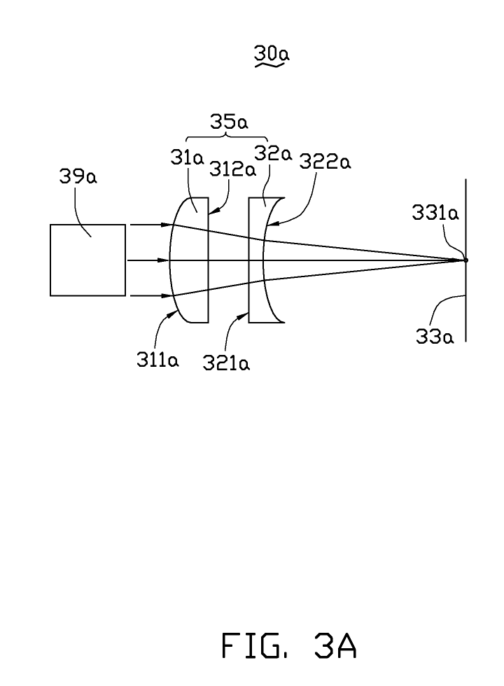

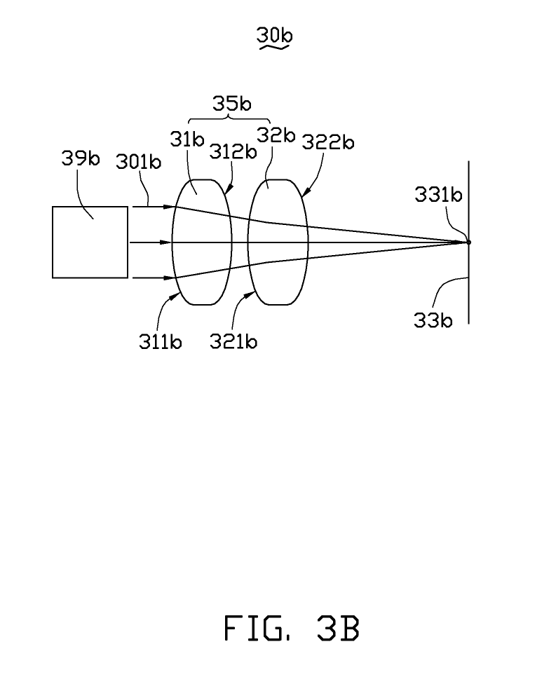

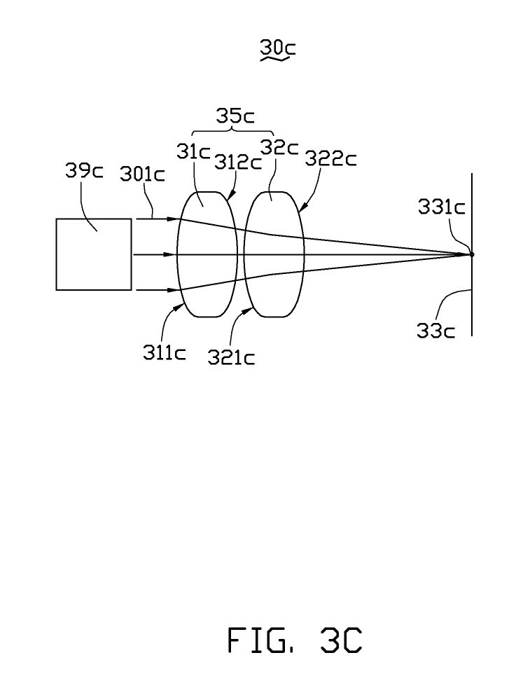

Referring to FIG. 3A, a laser device 30a of a first example of a third embodiment is provided. An optical module 35a includes a first optical element 31a and a second optical element 32a. The first optical element 31a has a first surface 311a and a second surface 312a at opposite sides thereof. The first surface 311a faces toward a laser source 39a. The second optical element 32a has a third surface 321a facing toward the first optical element 31a, and a fourth surface 322a facing toward a focal plane 33a. The first surface 311a is spherical, and the second surface 312a is flat. The third surface 321a is flat, and the fourth surface 322a is a concave aspherical surface. It is noted that in various other examples of the third embodiment and/or in variations of the first example, the first surface 311a, the second surface 312a, the third surface 321a and the fourth surface 322a may each be flat, spherical, cylindrical or aspherical as desired, so long as at least one of them is aspherical.

Referring to FIG. 3B, a laser device 30b of a second example of the third embodiment is provided. The second example is similar to the first example. An optical module 35b includes a first optical element 31b and a second optical element 32b. The first optical element 31b has a first surface 311b and a second surface 312b at opposite sides thereof. The first surface 311b faces toward a laser source 39b. The second optical element 32b has a third surface 321b facing toward the first optical element 31b, and a fourth surface 322b facing toward a focal plane 33b. The first surface 311b and the second surface 312b are spherical. The third surface 321b and the fourth surface 322b are convex aspherical surfaces.

Exemplary parameters of the second example are shown in Table I. The wavelength and beam diameter of a UV laser beam 301b are assumed to be 355 nm and 10.92 mm, respectively. In Table I, the thickness 1.00×10²⁰ mm is a distance between a beam-emergence surface of the laser source 39b and the spherical first surface 311b, inferring that the UV laser beam 301b entering the optical module 35b is collimated; the thickness 10.000 mm is a distance between the spherical first surface 311b and the spherical second surface 312b; the thickness 5.033 mm is a distance between the spherical second surface 312b and the aspherical third surface 321b; the thickness 10.703 mm is a distance between the aspherical third surface 321b and the aspherical fourth surface 322b; and the thickness 159.800 mm is a distance between the aspherical fourth surface 322b and the focal plane 33b. The material represents what medium the UV laser beam 301b enters after passing through the corresponding surface of the first or second optical element 31b, 32b.

TABLE I
Parameters of the optical elements 31b, 32b

Unit: mm

| | | | CONIC | |
|---|---|---|---|---|
| SURFACE | RADIUS | THICKNESS | CONSTANT | MATERIAL |
| Beam- | — | 1.00 × 10²⁰ | — | Air |
| emergence | | | | |
| surface | | | | |
| 311b | 117.717 | 10.000 | 0 | Silica |
| 312b | −1.018 × 10³ | 5.033 | 0 | Air |
| 321b | −2.603 × 10³ | 10.703 | 2.72 × 10⁴ | Silica |
| 322b | −307.307 | 159.800 | 20.61 | Air |

In the second example, a light spot 331b can be formed at the focal plane 33b by the UV laser beam 301b passing through the first and second optical elements 31b, 32b. After optimization of conic constants or aspheric coefficients of the aspherical surfaces 321b, 322b, as listed in Table I, the width of half-maximum point spread function is 5.8 μm at the focal plane 33b, while the distance from the furthest focusing position of the UV laser beam 301b to the focal plane 33b is ±200 μm. This means the size of the light spot 331b (which is equivalent to the resolution of the UV laser beam 301b) is 5.8 μm and the DOF of the laser device 30 is 400 μm.

Referring to FIG. 3C, a laser device 30c of a third example of the third embodiment is provided. The third example is similar to the first example. An optical module 35c includes a first optical element 31c and a second optical element 32c. The first optical element 31c has a first surface 311c and a second surface 312c at opposite sides thereof. The first surface 311c faces toward a laser source 39c. The second optical element 32c has a third surface 321c facing toward the first optical element 31c, and a fourth surface 322c facing toward a focal plane 33c. The first surface 311c and the second surface 312c are aspherical. The third surface 321c and the fourth surface 322c are aspherical.

Exemplary parameters of the third example are shown in Table II. The wavelength and beam diameter of a UV laser beam 301c are assumed to be 355 nm and 10.92 mm, respectively. In Table II, the thickness 1.00×10²⁰ mm is a distance between a beam-emergence surface of the laser source 39c and the first surface 311c, inferring that the UV laser beam 301c entering the optical module 35c is collimated; the thickness 7.595 mm is a distance between the first surface 311c and the second surface 312c; the thickness 5.028 mm is a distance between the second surface 312c and the third surface 321c; the thickness 4.497 mm is a distance between the third surface 321c and the fourth surface 322c; and the thickness 60.190 mm is a distance between the fourth surface 322c and the focal plane 33c. The material represents what medium the UV laser beam 301c enters after passing through the corresponding surface of the first or second optical element 31c, 32c.

TABLE II
Parameters of the optical elements 31c, 32c

Unit: mm

| | | | CONIC | |
|---|---|---|---|---|
| SURFACE | RADIUS | THICKNESS | CONSTANT | MATERIAL |
| Beam- | — | 1.00 × 10²⁰ | — | Air |
| emergence | | | | |
| surface | | | | |
| 311c | 40.064 | 7.595 | 2.02 | Silica |
| 312c | −190.280 | 5.028 | −1.24 × 10³ | Air |
| 321c | −18.538 | 4.497 | −1.05 × 10⁶ | Silica |
| 322c | 0.239 | 60.190 | −7.04 × 10⁵ | Air |

In the third example, a light spot 331c can be formed at the focal plane 33c by the UV laser beam 301c passing through the first and second optical elements 31c, 32c. After optimization of conic constants or aspheric coefficients of the aspherical surfaces 311c, 312c, 321c, 322c, as listed in Table II, the width of half-maximum point spread function is 2 μm at the focal plane 33c, while the distance from the furthest focusing position of the UV laser beam 301c to the focal plane 33c is ±47 μm. This means the size of the light spot 331c (which is equivalent to the resolution of the UV laser beam 301c) is 2 μm and the DOF of the laser device 30 is 94 μm.

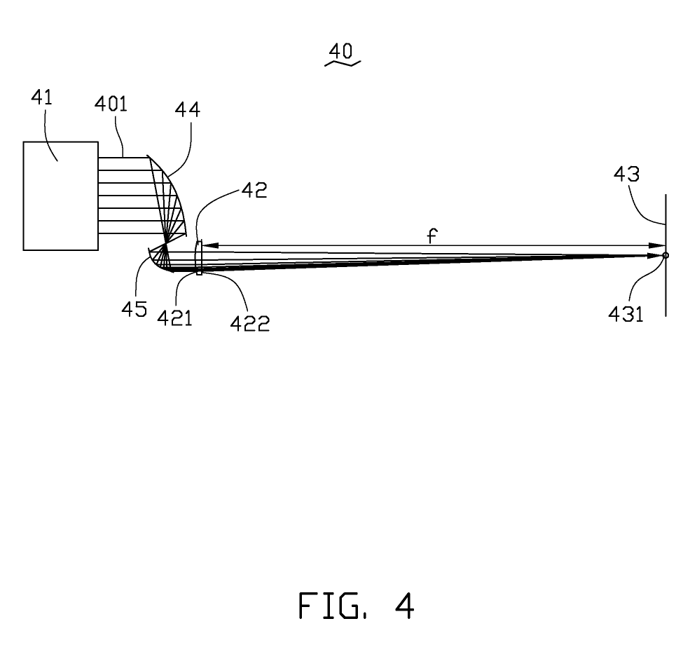

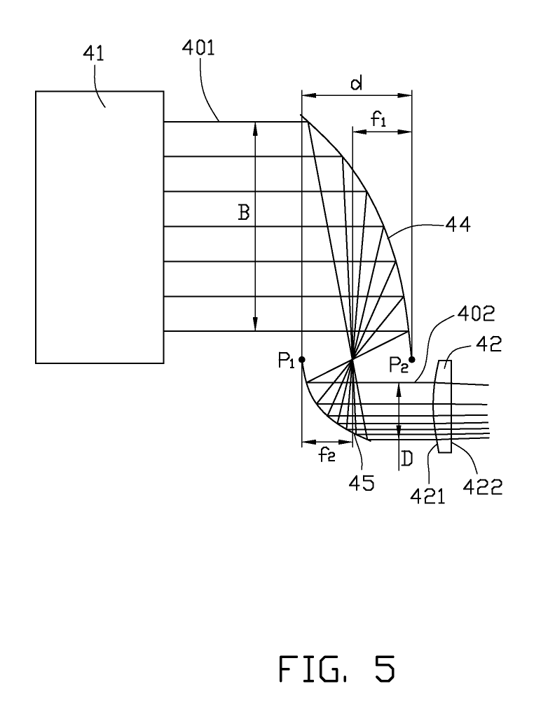

Referring to FIGS. 4 and 5, a fourth embodiment of a laser device 40 is provided. The laser device 40 includes an optical module 42, a first reflective element 44, and a second reflective element 45. The optical module 42 includes a single focus lens having a first surface 421 and a second surface 422 at opposite sides thereof. In the present embodiment, the first surface 421 is spherical, and the second surface 422 is flat. The focus lens is made of glass with a refractive index=1.5. In alternative embodiments, the first surface 421 or the second surface 422 may be aspherical. The first reflective element 44 and the second reflective element 45 are disposed on a light path of a UV laser beam 401, between a laser source 41 and the optical module 42. Each of the reflective elements 44, 45 may be ellipsoid mirrors or paraboloid mirrors. In the present embodiment, the reflective elements 44, 45 are paraboloid mirrors. A diameter of the UV laser beam 401 is equal to B, and a diameter of a modulated UV laser beam 402 reflected by the reflective element 45 is equal to D. So a magnification M can be defined as D/B. According to the theory of planar beam expanders, a focal length f₁ of the reflective element 44 and a focal length f₂ of the reflective element 45 have relationships with the magnification M and a distance d spanned by the apexes of the reflective elements 44, 45 (as measured along the P̅₁̅ P̅₂̅ axis as shown in FIG. 5) which satisfy the following equations:

|f₁|+|f₂|=d (1)

|f₂|/|f₁|=M (2)

If the laser device 40 is dominated by the diffraction effect, according to diffraction theory, the diffractive depth of focus (DDOF) D_{DOF} satisfies the equations:

D_{DOF}=±c₁Fₙ²λ (3)

Fₙ=f/D (4)

wherein c₁ is a constant, f is the focal length of the optical module 42, Fₙ is the f-number of the optical module 42, and λ is a wavelength of the UV laser beam 401 in air.

A diameter w of a light spot 431 formed at a focal plane 43 satisfies the equation:

w=c₂λFₙ (5)

wherein, c₂ is a constant, which is 2.44 for Rayleigh criterion.

Then from (3) and (5), the following equation can be derived.

D_{DOF}=±cw²/λ (6)

wherein, c=c₁/c₂² is also a constant. It means that when the diameter w of the light spot 431 and the wavelength λ are given, the D_{DOF} is then restricted.

Alternatively, if the laser device 40 is dominated by geometric optics, from the theory of geometrical depth of focus (GDOF), the G_{DOF} is related to the diameter w of the light spot 431 and the f-number Fₙ of the optical module 42, and satisfies the following equation:

G_{DOF}=2Fₙw (7)

From equations (2), (4) and (7), the focal lengths f₁,f₂ of the two paraboloid reflective elements 44, 45 can be related to the G_{DOF} and the diameter w of light spot 431, wherein the following equation is satisfied:

|f₂|/|f₁|=2fw/BG_{DOF} (8)

Consequently, using equations (1) and (8), one can derive the f₁ and f₂ for the design of the two paraboloid reflective elements 44, 45.

A numerical example is given as follows. It is assumed that the laser device 40 is designed for the incident UV laser beam 401 to have a diameter B=10.92 mm, and for the distance d spanned by the apexes of the reflective elements 44, 45 to be equal to 5 mm. If the working distance (usually equivalent to the effective focal length of the focus lens 42) is 160 mm, then from equations (1) and (8), the focal lengths f₁,f₂ of the two paraboloid reflective elements 44, 45 are: |f₁|=3.6595 mm and |f₂|=1.3405 mm. The wavelength λ of the UV laser beam 401 is assumed to be 355 nm. Parameters of the optical module 42 and the reflective elements 44 and 45 may follow the data in Table III. In Table III, the thickness 1.00×10²⁰ mm is a distance between a beam-emergence surface of the laser source 41 and the reflective element 44, inferring that the UV laser beam 401 transmitted to the reflective element 44 is collimated. The thickness −5 mm is a distance between the reflective elements 44 and 45, wherein the negative sign represents that the UV laser beam 401 is reflected by the reflective element 44 toward the reflective element 45. The thickness 10 mm is a distance between the reflective element 45 and the first surface 421; the thickness 1 mm is a distance between the first surface 421 and the second surface 422; and the thickness 160.2 mm is a distance between the second surface 422 and the focal plane 43. The material represents what medium the UV laser beams 401 and 402 enter after reflected by or passing through the corresponding surface of the reflective element 44 or 45 or optical module 42.

TABLE III
Parameters of the reflective elements 44, 45 and optical module 42

Unit: mm

| | | | CONIC | |
|---|---|---|---|---|
| SURFACE | RADIUS | THICKNESS | CONSTANT | MATERIAL |
| Beam- | — | 1.00 × 10²⁰ | — | Air |
| emergence | | | | |
| surface | | | | |
| 44 | −7.319 | −5 | −1 | Reflection |
| 45 | 2.681 | 10 | −1 | Reflection |
| 421 | 80 | 1 | 0 | Glass |
| 422 | 0 | 160.2 | 0 | Air |

In the present embodiment, the light spot 431 can be formed at the focal plane 43 by the UV laser beam 401 after being reflected by reflective elements 44 and 45 and passing through the optical element 42. After optimization of the reflective elements 44, 45 and the optical element 42, as listed in Table III, the width of half-maximum point spread function is 12.9 μm at the focal plane 43, while the distance from the furthest focusing position of the UV laser beam 401 to the focal plane 43 is ±200 μm. This means the size of the light spot 431 (which is equivalent to the resolution of the UV laser beam 401) is 12.9 μm and the DOF of the laser device 40 is 400 μm.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A laser device comprising:
a laser source configured for emitting an ultraviolet (UV) laser beam with a single wavelength; and
an optical module comprising a first optical element disposed on a light path of the UV laser beam, wherein the first optical element has a first surface and a second surface at opposite sides thereof, the first surface faces toward the laser source, and at least one of the first and second surfaces is aspherical such that the UV laser beam is capable of focusing on a focal plane.

2. The laser device of claim 1, wherein one of the first and second surfaces is aspherical, and the other one of the first and second surfaces is selected from the group consisting of flat, spherical, cylindrical and aspherical.

3. The laser device of claim 1, wherein the first optical element is substantially an axicon type lens.

4. The laser device of claim 1, wherein the optical module further comprises a second optical element aligned with the first optical element, the second optical element has a third surface and a fourth surface at opposite sides thereof, and the third surface faces toward the first optical element.

5. The laser device of claim 4, wherein at least one of the third and fourth surfaces is aspherical.

6. The laser device of claim 4, wherein one of the third and fourth surfaces is aspherical, and the other one of the third and fourth surfaces is selected from the group consisting of flat, spherical, cylindrical and aspherical.

7. The laser device of claim 1, wherein the optical module further comprises a first reflecting element and a second reflecting element both disposed on the light path of the UV laser beam between the laser source and the first optical element, wherein a focal length f₁ of the first reflective element and a focal length f₂ of the second reflective element satisfy the equations:

|f₁|+|f₂|=d

|f₂|/|f₁|=2fw/BG_{DOF}
wherein d represents a distance spanned by apexes of the first reflecting element and the second reflecting element, f represents a focal length of the first optical element, w represents a diameter of a light spot formed by the UV laser beam, B represents a diameter of the UV laser beam, and G_{DOF} represents a geometrical depth of focus of the laser device.

8. The laser device of claim 7, wherein each of the first reflecting element and the second reflecting element is selected from the group consisting of an ellipsoid mirror and a paraboloid mirror.
